(19) United States
(12) Patent Application Publication
(10) Pub. No.: US 2019/0085993 A1
(43) Pub. Date: Mar. 21, 2019

(54) WATERWAY ASSEMBLY FOR A FAUCET

(71) Applicant: Delta Faucet Company, Indianapolis, IN (US)

(72) Inventors: Alfred Charles Nelson, Westfield, IN (US); Adam M. DeVries, Anderson, IN (US)

(21) Appl. No.: 16/117,852

(22) Filed: Aug. 30, 2018

Related U.S. Application Data
(60) Provisional application No. 62/559,396, filed on Sep. 15, 2017.

(51) Int. Cl. F16K 11/00; E03C 1/04

(52) U.S. Cl. CPC F16K 19/006; E03C 1/04

(57) ABSTRACT

A waterway assembly for a faucet including a plurality of tubular assemblies. Each tubular assembly includes a collar overmolded onto an end thereof and press fit onto a barbed fitting of an adapter.

### CROSS-REFERENCE TO RELATED APPLICATION

The present application claims priority to U.S. Provisional Patent Application Ser. No. 62/559,396, filed Sep. 15, 2017, the disclosure of which is expressly incorporated herein by reference.

### BACKGROUND AND SUMMARY OF THE DISCLOSURE

The present invention relates generally to plumbing fixtures and, more particularly, to a waterway assembly for a faucet.

Waterway assemblies for use within faucets are known in the art. For example, U.S. Pat. No. 8,365,770 to Thomas et al. discloses a faucet including a molded waterway assembly having a plurality of tubes overmolded within a valve interface member. U.S. Pat. No. 8,944,093 to Veros et al. discloses a fluid delivery device including a waterway assembly, a valve assembly, and a waterway adapter that fluidly couples the waterway assembly to the valve assembly. U.S. Pat. Nos. 8,365,770 and 8,944,093 are expressly incorporated herein by reference.

According to an illustrative embodiment of the present disclosure, a waterway assembly for a faucet includes a waterway adapter having a body with a valve interface member and a plurality of downwardly extending connecting tubes, each having a plurality of securing members. A plurality of flexible tubular members are formed of a polymer and have opposing first and second ends. A collar is overmolded around the first end of each flexible tubular member, wherein the connecting tubes of the waterway adapter are received within the first ends of the flexible tubular members.

According to another illustrative embodiment of the present disclosure, a waterway assembly for a faucet includes a waterway adapter having a body with a valve interface member and a plurality of connecting tubes, the plurality of connecting tubes including a hot water connecting tube, a cold water connecting tube, and a water outlet connecting tube. The waterway assembly further includes a plurality of tubular assemblies, each of the tubular assemblies including a flexible tubular member formed of a polymer and having opposing first and second ends, and a collar supported by the first end of the flexible tubular member. The plurality of flexible tubular members include a hot water inlet tubular member, a cold water inlet tubular member, and an outlet water tubular member. The hot water connecting tube is received within the first end of hot water inlet tubular member, the hot water connecting tube expanding an inner diameter of the first end of the hot water inlet tubular member by at least 20 percent. The cold water connecting tube is received within the first end of cold water inlet tubular member, the cold water connecting tube expanding an inner diameter of the first end of the cold water inlet tubular member by at least 20 percent. The outlet water connecting tube is received within the first end of outlet water tubular member, the outlet water connecting tube expanding an inner diameter of the first end of the outlet water tubular member by at least 20 percent.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF DRAWINGS

A detailed description of the drawings particularly refers to the accompanying figures, in which:

FIG. 1 is a diagrammatic view of a faucet including an illustrative waterway assembly of the present disclosure;

FIG. 2 is an exploded perspective view of the illustrative waterway assembly of FIG. 1;

FIG. 3 is a front plan view of the illustrative waterway assembly of FIG. 2;

FIG. 4 is a partial cross-sectional view of the illustrative waterway assembly taken along line 4-4 of FIG. 3;

FIG. 5 is a partial cross-sectional view of the illustrative waterway assembly taken along line 5-5 of FIG. 3;

FIG. 6 is a detailed cross-sectional view of a connecting tube of the waterway assembly of FIG. 2;

FIG. 7 is an exploded perspective view of an illustrative tubular assembly of the waterway assembly of FIG. 2;

FIG. 8 is a side elevational view of the illustrative tubular assembly of FIG. 7;

FIG. 9 is a cross-sectional view of the illustrative tubular assembly taken along line 9-9 of FIG. 8;

FIG. 10 is a perspective view of an illustrative collar of the tubular assembly of FIG. 7;

FIG. 11 is a side elevational view of the illustrative collar of FIGS. 10; and

FIG. 12 is cross-sectional view of the illustrative collar taken along line 12-12 of FIG. 11.

### DETAILED DESCRIPTION OF THE DRAWINGS

For the purposes of promoting an understanding of the principles of the present disclosure, reference will now be made to the embodiments illustrated in the drawings, which are described herein. The embodiments of the invention described herein are not intended to be exhaustive or to limit the invention to the precise form disclosed. Rather, the embodiments selected for a description have been chosen to enable one skilled in the art to practice the invention. Although the disclosure is described in connection with water, it should be understood that additional types of fluids may be used.

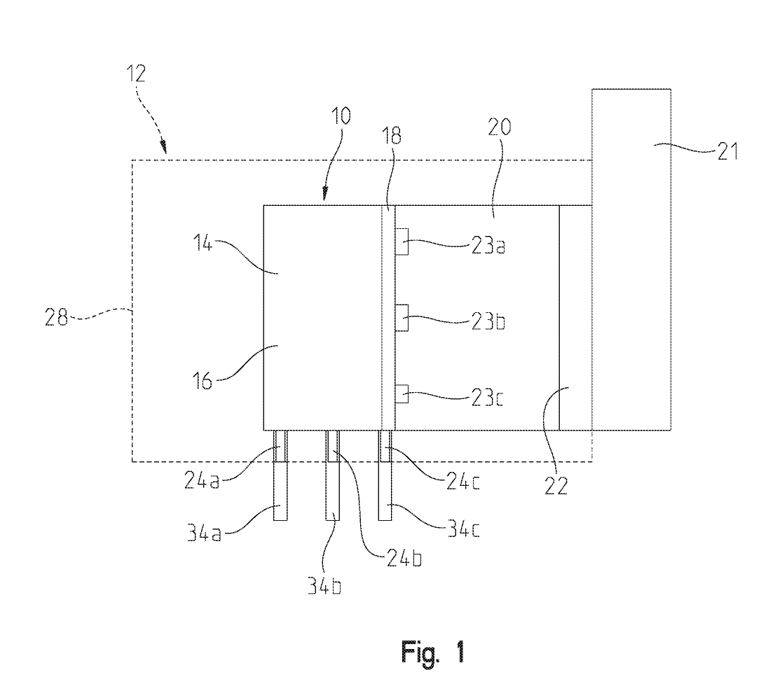

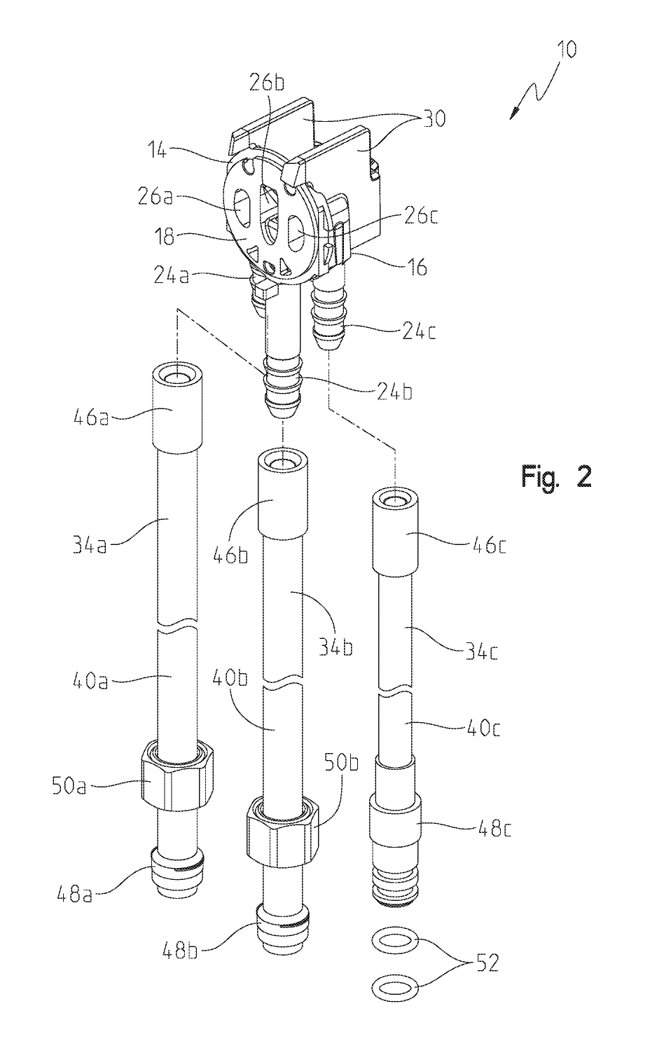

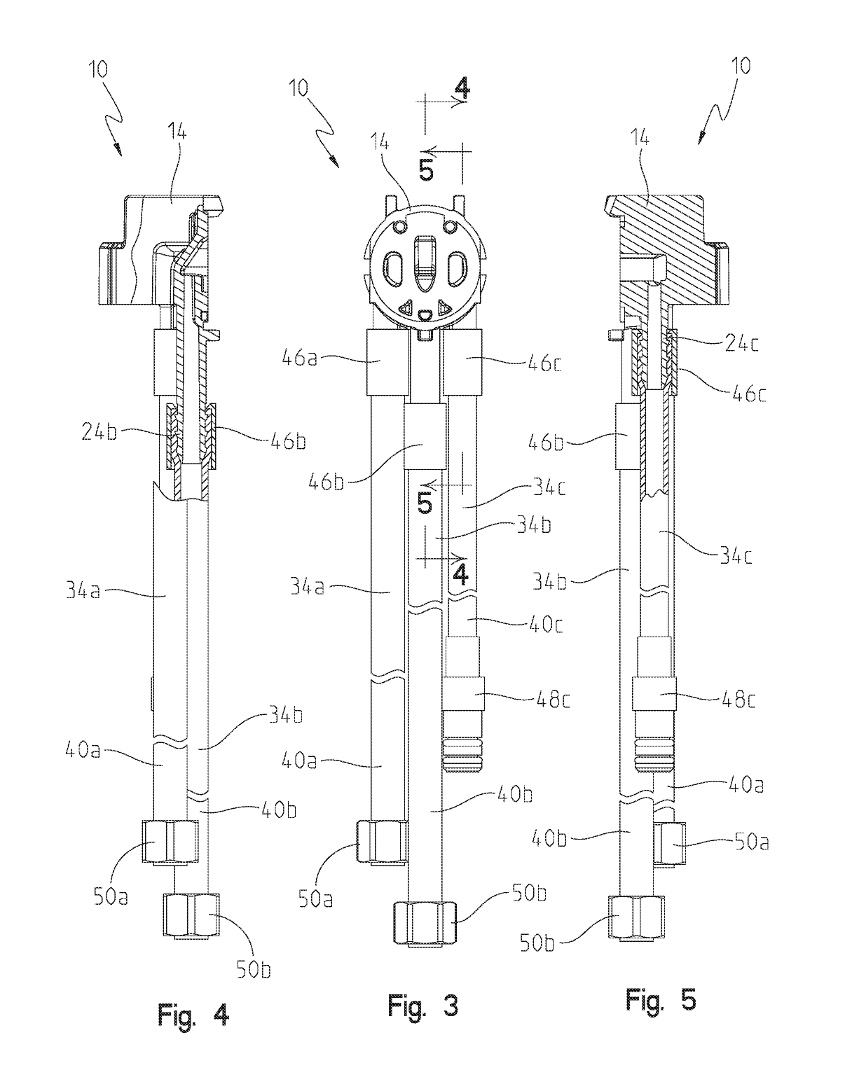

With reference initially to FIGS. 1-5, an illustrative waterway assembly 10 for a faucet 12 includes an adapter 14 having a body 16 supporting a valve interface plate 18. The adapter 14 is illustratively molded from a polymer, such as a glass fiber reinforced polysulfone, to form unitary body 16. A mixing valve 20 is illustratively coupled to the valve interface plate 18. A handle 21 for manipulation by a user is illustratively coupled to a movable valve element 22 of the mixing valve 20 (FIG. 1). More particularly, movement of the valve element 22 controls water flow within the mixing valve 20 from a hot water inlet port 23a and a cold water inlet port 23b, to a mixed water outlet port 23c. Additional details of an illustrative mixing valve 20 are provided in U.S. Pat. No. 7,753,074, the disclosure of which is expressly incorporated herein by reference.

A plurality of connecting tubes 24 extend downwardly from the body 16 of the adapter 14 and are in fluid communication with openings 26 in the valve interface plate 18. More particularly, a hot water connecting tube 24a, a cold water connecting tube 24b, and a water outlet connecting tube 24c are fluidly coupled with a hot water opening 26a, a cold water opening 26b, and an outlet water opening 26c, respectively. The hot water opening 26a, the cold water opening 26b and the outlet water opening 26c are in fluid communication with corresponding hot water port 23a, cold water port 23b, and outlet water port 23c in the mixing valve 20.

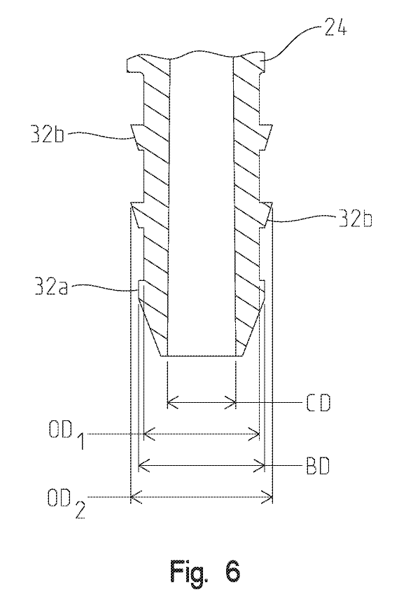

The body 16 of the adapter 14 is configured to be received within a hub 28 of the faucet 12, and illustratively includes support rails 30 for engaging an inner surface of the hub 28. The connecting tubes 24 are illustratively nipples including a plurality of annular securing members, such as radially outwardly extending ribs or barbs 32 (FIG. 6).

The illustrative waterway assembly 10 further includes a plurality of flexible tubular assemblies 34, including opposing first and second ends 36 and 38, which are coupled to the adapter 14. The flexible tubular assemblies 34 illustratively include a hot water inlet tubular assembly 34a, a cold water inlet tubular assembly 34b, and a water outlet tubular assembly 34c, which are fluidly coupled to the connecting tubes 24a, 24b, 24c, respectively, of the adapter 14. Hot water from a hot water source (not shown) is supplied from the hot water tubular assembly 34a to the hot water inlet port 23a of the mixing valve 20, and cold water from a cold water source (not shown) is supplied from the cold water tubular assembly 34b to the cold water inlet port 23b of mixing valve 20. Illustratively, operation of the mixing valve 20 through the handle 21 moves the valve element 22 to control the flow rate and mixing (temperature) of water supplied from the hot water inlet tubular assembly 34a and the cold water inlet tubular assembly 34b to the mixed water outlet port 23c and the water outlet tubular assembly 34c, in a known manner.

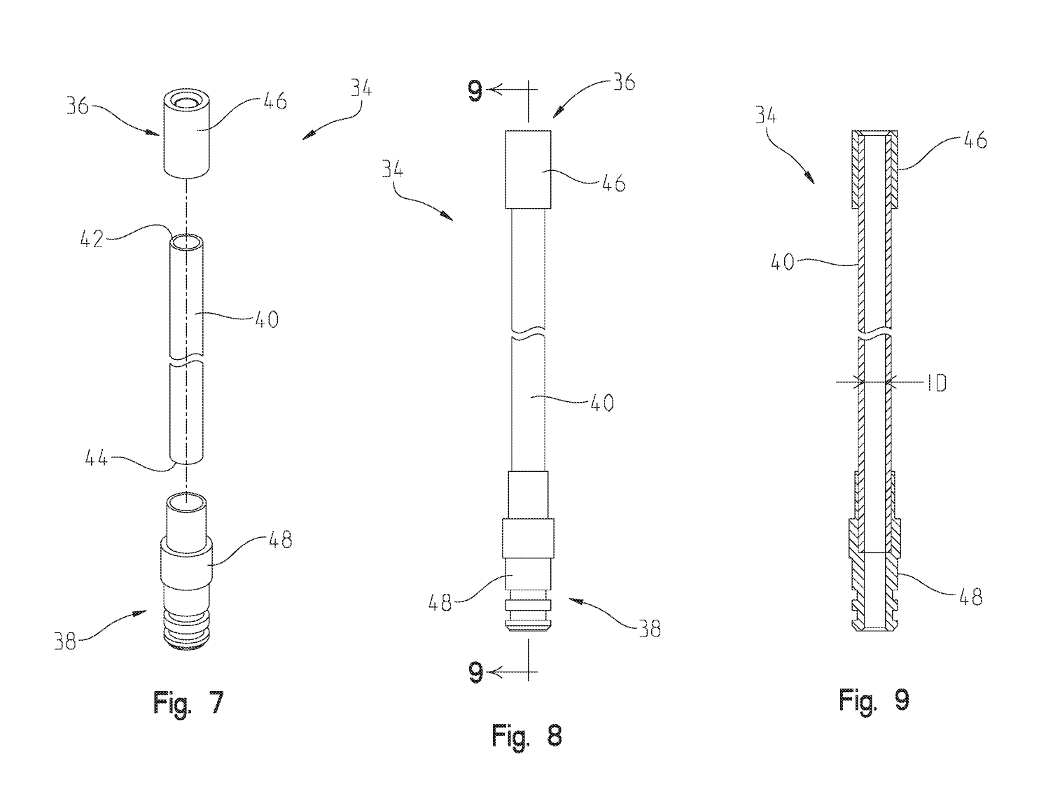

With reference to FIGS. 7-9, each of the tubular assemblies 34 includes a tubular member or tube 40 extending between opposing first and second ends 42 and 44, and illustratively formed of a polymer, such as polyethylene. The tubular members 40 illustratively include a hot water inlet tubular member 40a, a cold water inlet tubular member 40b, and a water outlet tubular member 40c. Cylindrical reinforcing collars or cuffs 46 are coupled to the first ends 42 of the tubular members 40, and quick connect fittings 48 are coupled to the second ends 44 of the tubular members 40. More particularly, the collars 46 and fittings 48 are illustratively formed of a polymer, such as polyethylene, overmolded onto the tubular member 40. Each respective collar 46a, 46b, 46c illustratively concentrically receives the first end 42 of one of the respective tubular members 40a, 40b, 40c, while each respective fitting 48a, 48b, 48c illustratively concentrically receives the second end 44 of one of the respective tubular members 40a, 40b, 40c.

The fittings 48a and 48b on the tubular members 40a and 40b are illustratively configured to fluidly couple the second ends 38 of the hot and cold water inlet tubular assemblies 34a and 34b with conventional fluid couplings, such as hot and cold water stops (not shown). A nut 50a, 50b may concentrically receive the tubular member 40a, 40b and cooperate with the fittings 48a, 48b. The fitting 48c on the tubular member 40c is illustratively configured to fluidly couple the second end 38 of the water outlet tubular assembly 34c to a water outlet, such as a sprayhead (not shown). O-rings 52 may be coupled to the fitting 48c for providing a fluid seal. After overmolding, each assembly 34 (e.g., tubular member 40, collar 46, and fitting 48) may be cross-linked to form a completed PEX tubular assembly 34.

The first ends 42 of the tubular members 40 and associated collars 46 of the tubular assemblies 34 are illustratively press-fit onto the barbs 32 of the connecting tubes 24 to achieve a sealed joint without the need for additional sealing components, such as o-rings, gaskets, and/or crimped secondary collars or ferrules. In an illustrative embodiment, the connecting tubes 24 and the tubular members 40 (and associated collars 46) have different material properties, wherein the connecting tubes 24 have a greater hoop strength than the first ends 36 of the tubular assemblies 34. As such, the connecting tubes 24 maintain their general shapes, while expanding the first ends 42 of the tubular members 40.

Illustratively, the first end 36 of each tubular assembly 34 is pressed on the respective connecting tube 24 with a diameter expansion of the first end 42 of the tubular member 40 of at least 20 percent. In one illustrative embodiment, the diameter expansion of the first end 42 of the tubular member 40 is at least 40 percent. Further illustratively, the diameter expansion of the first end 42 of the tubular member 40 is at least 50 percent. The diameter expansion of the tubular member 40 depends upon the resistance provided by the collar 46 which, in turn, is dependent upon the material and the wall thickness (T) of the collar 46 (FIG. 12).

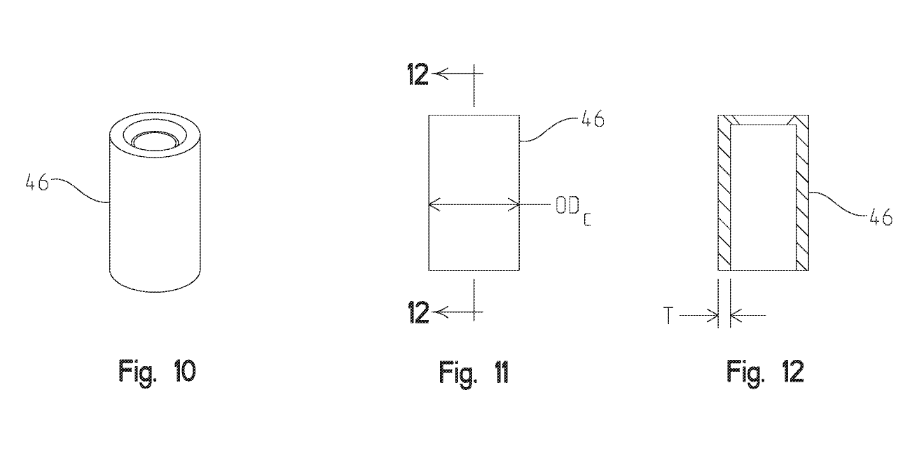

In one illustrative embodiment, the tubular member 40 is ⅜ inch tubing, such that the inner diameter (ID) of the tubular member 40 is approximately 0.235 inches (FIG. 9). The outer diameter (OD_{C}) of the collar 46 is illustratively 0.430 inches (FIG. 11), while the wall thickness (T) of the collar 46 is illustratively 0.048 inches (FIG. 12). As shown in the illustrative embodiment of FIG. 6, a base diameter (BD) of each connecting tube 24 is 0.310 inches (+/−0.003 inches), a first barb 32a outer diameter (OD₁) is 0.335 inches (+/−0.003 inches), and a second barb 32b outer diameter (OD₂) is 0.370 inches (+/−0.003 inches). An illustrative inner diameter (CD) of the connecting tube 24 is illustratively 0.220 inches.

In the illustrative embodiment, the diametric expansion of the tubular member 40 due to the first barb 32a is 42 percent (0.335-0.235/0.235), while diametric expansion of the tubular member 40 due to the second barb 32b is 57 percent (0.370-0.235/0.235). Illustratively, the dimensions ID, OD₁ and OD₂ are fixed by crosslinking prior to insertion of the connecting tube 24 into the tubular member 40. The collars 46 reinforce the first ends 42 of the tubular members 40, thereby allowing for greater radial or diametric expansion from the connecting tubes 24.

Crosslinking imparts a “memory” to the polymeric tubing's original dimensions, and upon deformation of the same, will tend to resort back to the original dimension when crosslinked upon the application of a transforming force. Using this shape-memory feature facilitates sealing engagement between the first end 42 of the tubular member 40 and the associated barbs 32 of the connecting tube 24.

An illustrative method of manufacturing the waterway assembly 10 includes providing polymeric tubular member 40, overmolding polymeric collar 46 on the first end 42 of tubular member 40, overmolding polymeric fitting 48 on the second end 44 of the tubular member 40 to define tubular assembly 34, and then crosslinking the tubular assembly 34. Each such tubular assembly 34 has its first end 36 press fit onto one of the connecting tubes 24 of the adapter 14. It should be appreciated that the number and arrangement of the tubular assemblies 34 and associated connecting tubes 24 may vary. The finished waterway assembly 10 is then inserted within the hub 28 of the faucet 12. The mixing valve 20 is then fluidly coupled with the valve interface plate 18 and secured within the hub 28 by a coupler, such as a mounting nut (not shown).

As used in the present application, the term “overmold” means the process of injection molding a second polymer over a first polymer, wherein the first and second polymers may or may not be the same. In one illustrative embodiment, the composition of the overmolded polymer may be such that it is capable of at least some melt fusion with the polymeric tube. There are several means by which this may be affected. One of the simplest procedures is to ensure that at least a component of the polymeric tube and that of the overmolded polymer is the same. Alternatively, it would be possible to ensure that at least a portion of the polymer composition of the polymeric tube and that of the overmolded polymer is sufficiently similar or compatible so as to permit the melt fusion or blending or alloying to occur at least in the interfacial region between the exterior of the polymeric tube and the interior region of the overmolded polymer.

In an illustrative embodiment, the tubular members 40 and the collars 46 are made from high density polyethylene which is crosslinked. PEX is known to contain crosslinked bonds in the polymer structure changing the thermoplastic into a thermoset. Crosslinking may be accomplished during or after the molding of the part. There are three classifications of PEX, referred to as PEX-A, PEX-B, and PEX-C. PEX-A is made by the peroxide (Engel) method. In the PEX-A method, peroxide blended with the polymer performs crosslinking above the crystal melting temperature. The polymer is typically kept at high temperature and pressure for long periods of time during the extrusion process. PEX-B is formed by the silane method, also referred to as the “moisture cure” method. In the PEX-B method, silane blended with the polymer induces crosslinking during molding and during secondary post-extrusion processes, producing crosslinks between a crosslinking agent. The process is accelerated with heat and moisture. The crosslinked bonds are formed through silanol condensation between two grafted vinyltrimethoxysilane units. PEX-C is produced by application of an electron beam using high energy electrons to split the carbon-hydrogen bonds and facilitate crosslinking.

Crosslinking imparts shape memory properties to polymers. Shape memory materials have the ability to return from a deformed state (e.g. temporary shape) to their original crosslinked shape (e.g. permanent shape), typically induced by an external stimulus or trigger, such as a temperature change. Alternatively, or in addition to temperature, shape memory effects can be triggered by an electric field, magnetic field, light, or a change in pH, or even the passage of time.

Additional details on overmolding and crosslinking of fluid carrying components are provided in U.S. Pat. Nos. 8,220,126 and 8,844,111 to Yunk et al., the disclosures of which are expressly incorporated by reference herein.

Although the invention has been described in detail with reference to certain preferred embodiments, variations and modifications exist within the spirit and scope of the invention as described and defined in the following claims.

1. A waterway assembly for a faucet comprising:
a waterway adapter including a body having a valve interface member and a plurality of downwardly extending connecting tubes; and
a plurality of tubular assemblies, each of the tubular assemblies including:
a flexible tubular member formed of a polymer and having opposing first and second ends; and
a collar overmolded around the first end of the flexible tubular member;
wherein each of the connecting tubes of the waterway adapter is received within the first end of one of the flexible tubular members.

2. The waterway assembly of claim 1, wherein the connecting tubes of the waterway adapter includes a nipple having a plurality of barbs concentrically within the first end of the flexible tubular member.

3. The waterway assembly of claim 2, wherein the nipples expand an inner diameter of the flexible tubular members by at least 20 percent.

4. The waterway assembly of claim 3, wherein the nipples expand an inner diameter of the flexible tubular members by at least 40 percent.

5. The waterway assembly of claim 2, wherein the flexible tubular member and the collar of each of the tubular assemblies are cross-linked as an assembly.

6. The waterway assembly of claim 5, wherein the flexible tubular member and the collar of each of the tubular assemblies comprise a cross-linked polyethylene.

7. The waterway assembly of claim 1, wherein the waterway adapter further includes rearwardly extending rails configured to be received within a faucet hub.

8. The waterway assembly of claim 1, wherein the plurality of flexible tubular members include a hot water inlet tube, a cold water inlet tube, and a water outlet tube.

9. A waterway assembly for a faucet comprising:
a waterway adapter including a body having a valve interface member and a plurality of connecting tubes, the plurality of connecting tubes including a hot water connecting tube, a cold water connecting tube, and a water outlet connecting tube; and
a plurality of tubular assemblies, each of the tubular assemblies including:
a flexible tubular member formed of a polymer and having opposing first and second ends; and
a collar supported by the first end of the flexible tubular member;
wherein the plurality of flexible tubular members include a hot water inlet tubular member, a cold water inlet tubular member, and a water outlet tubular member;
the hot water connecting tube received within the first end of hot water inlet tubular member, the hot water connecting tube expanding an inner diameter of the first end of the hot water inlet tubular member by at least 20 percent;
the cold water connecting tube received within the first end of the cold water inlet tubular member, the cold water connecting tube expanding an inner diameter of the first end of the cold water inlet tubular member by at least 20 percent; and
the outlet water connecting tube received within the first end of the water outlet tubular member, the water outlet connecting tube expanding an inner diameter of the first end of the water outlet tubular member by at least 20 percent.

10. The waterway assembly of claim 9, wherein the collar is overmolded around the first end of the flexible tubular member.

11. The waterway assembly of claim 10, wherein the flexible tubular member and the collar of each of the tubular assemblies are cross-linked as an assembly.

12. The waterway assembly of claim 11, wherein the flexible tubular member and the collar of each of the tubular assemblies comprise a cross-linked polyethylene.

13. The waterway assembly of claim 9, wherein the connecting tubes of the waterway adapter includes a nipple having a plurality of barbs concentrically within the first end of the flexible tubular member.

14. The waterway assembly of claim 13, wherein the nipples expand an inner diameter of the flexible tubular members by at least 50 percent.

15. The waterway assembly of claim 9, wherein the waterway adapter further includes rearwardly extending rails configured to be received within a faucet hub.

16. A method of manufacturing a waterway assembly, the method comprising the steps of:
providing a polymeric tube;
overmolding a collar on a first end of the polymeric tube;
overmolding a fitting on a second end of the polymeric tube to define a tubular assembly;
providing a waterway adapter including a body having a valve interface member and a plurality of connecting tubes; and
press-fitting the first end of the polymeric tube onto one of the connecting tubes of the waterway adapter.

17. The method of claim 16, further comprising the step of inserting the waterway adapter within a faucet hub.

18. The method of claim 16, further comprising the step of cross-linking the tubular assembly.

19. The method of claim 16, wherein the press-fitting step includes expanding an inner diameter of the polymeric tube by at least 20 percent.
